(19) United States
(12) Patent Application Publication
(10) Pub. No.: US 2006/0224584 A1
(43) Pub. Date: Oct. 5, 2006

(54) Automatic linear text segmentation

(75) Inventor: Robert Jenson Price, Ashburn, VA (US)

Correspondence Address: STERNE, KESSLER, GOLDSTEIN & FOX PLLC, 1100 NEW YORK AVENUE, N.W., WASHINGTON, DC, 20005, US

(73) Assignee: Content Analyst Company, LLC, Reston, VA (US)

(21) Appl. No.: 11/316,837

(22) Filed: Dec. 27, 2005

Related U.S. Application Data
(60) Provisional application No. 60/666,733, filed on Mar. 31, 2005.

(51) Int. Cl. G06F 17/30

(52) U.S. Cl. 707/6

(57) ABSTRACT

An embodiment of the present invention provides a method for automatically subdividing a document into conceptually cohesive segments. The method includes the following steps: subdividing the document into contiguous blocks of text; generating an abstract mathematical space based on the blocks of text, wherein each block of text has a representation in the abstract mathematical space; computing similarity scores for adjacent blocks of text based on the similarity scores; and aggregating similar adjacent blocks of text based on the similarity scores.

### CROSS REFERENCE TO RELATED APPLICATIONS

This application claims benefit under 35 U.S.C. § 119(e) to U.S. Provisional Patent Application 60/666,733, entitled “Automatic Linear Text Segmentation Using Latent Semantic Indexing,” to Price, filed on Mar. 31, 2005, the entirety of which is hereby incorporated by reference as if fully set forth herein.

### BACKGROUND OF THE INVENTION

1. Field of the Invention

The present invention relates generally to information processing and data retrieval, and in particular to text segmentation.

2. Background

Information retrieval is of utmost importance in the current Age of Information. One method of information retrieval uses a technique called Latent Semantic Indexing (LSI). LSI is described, for example, in a paper by Deerwester, et al. entitled, “Indexing by Latent Semantic Analysis,” which was published in the Journal of the American Society For Information Science, vol. 41, pp. 391-407, the entirety of which is incorporated by reference herein. In LSI, each term and/or document from an indexed collection of documents is represented as a vector in an abstract mathematical vector space. Information retrieval is performed by representing a user's query as a vector in the same vector space, and then retrieving documents having vectors within a certain “proximity” of the query vector. The performance of LSI-based information retrieval often exceeds that of conventional keyword searching because documents that are conceptually similar to the query are retrieved even when the query and the retrieved documents use different terms to describe similar concepts.

Although LSI-based information retrieval is generally better than a keyword search, large documents that contain conceptually dissimilar segments of text are problematic for LSI-based information retrieval. These conceptually dissimilar segments of a large document can obscure sections of that document that may be relevant to a particular conceptual search. As a result, LSI-based information retrieval may not retrieve a large document even though a section or sections of the document are conceptually relevant to a user's query.

Given the foregoing, what is needed then is a method and computer program product for automatically subdividing large document texts into conceptually cohesive segments. The desired method and computer program product should segment the document according to the concepts contained within the document, and not according to a pre-existing topic list or set of dictionary definitions. The desired method and computer program product should be language independent. Finally, the desired method and computer program product should not depend on the visual structure of the document text in segmenting the document into conceptually cohesive segments.

### BRIEF SUMMARY OF THE INVENTION

The present invention provides a method and computer program product for automatically subdividing a large document into conceptually cohesive segments. Such conceptually cohesive segments may be automatically incorporated in a query space (such as an LSI space). This would enable a user query to find segments of a large document that are conceptually relevant to the query, despite any conceptually dissimilar segments that may be contained within the document. In addition, the conceptually cohesive segments could be directly displayed to a user. Furthermore, a large document could be automatically split into multiple conceptually cohesive documents that can each be treated as a separate document thereafter.

According to an embodiment of the present invention there is provided a method for automatically subdividing a document into conceptually cohesive segments. The method includes the following steps: subdividing the document into contiguous blocks of text; generating an abstract mathematical space based on the blocks of text, wherein each block of text has a representation in the abstract mathematical space; computing similarity scores for adjacent blocks of text based on the representations of the adjacent blocks of text; and aggregating similar adjacent blocks of text based on the similarity computation.

Another embodiment of the present invention provides a computer program product for automatically subdividing a document into conceptually cohesive segments. The computer program product includes a computer usable medium having computer readable program code means embodied in the medium for causing an application program to execute on an operating system of a computer. The computer readable program code means includes a first, second, third, and fourth computer readable program code means. The first computer readable program code means includes means for subdividing the document into contiguous blocks of text. The second computer readable program code means includes means for generating an abstract mathematical space based on the blocks of text, wherein each block of text has a representation in the abstract mathematical space. The third computer readable program code means includes means for computing similarity scores for adjacent blocks of text based on the representations of the adjacent blocks of text. The fourth computer readable program code means includes means for aggregating similar adjacent blocks of text based on the similarity scores.

Embodiments of the present invention provide various advantages over conventional approaches to linear text segmentation. For example, an embodiment of the present invention: (1) does not require that topics be defined prior to text segmentation (either by manual definition or as found in a predefined set of training documents); (2) does not require a dictionary of words, predefined topics, nor a priori training or background material; (3) is language independent, so long as one is dealing with a language wherein words and sentences can be extracted from the text; (4) is independent of the topics or domain of the text; (5) is not dependent upon the ability to parse sentence structure or language constructs; (6) does not require word stemming; (7) does not require keyword analysis to find hints or cues of topic changes; and (8) does not necessitate analysis of or dependence upon the visual structure of the text such as to find paragraph or chapter boundaries.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art(s) to make and use the invention.

FIG. 1 is a flowchart illustrating an automatic linear text segmentation method in accordance with an embodiment of the present invention.

FIG. 2 is a plot of “term” coordinates and “document” coordinates based on a two-dimensional singular value decomposition of an original “term-by-document” matrix in a single language.

FIG. 3 illustrates a collection of sentences or blocks of text identified in a document.

FIG. 4 illustrates the aggregation of sentences or blocks of text into segments in accordance with an embodiment of the present invention.

FIG. 5A depicts a block diagram illustrating a method for aggregating sentences or blocks of text of a document into conceptually cohesive items in accordance with an embodiment of the present invention.

FIG. 5B depicts a block diagram illustrating a method for computing similarity scores used in the aggregation of sentences or blocks of text in accordance with an embodiment of the present invention.

FIG. 6 is a block diagram of an exemplary computer system that may be used to implement an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

Introduction

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As is described in more detail below, an embodiment of the present invention provides a method for automatically subdividing a document into conceptually cohesive segments. The subdivision of the document is based on a conceptual similarity between blocks of text in the document. In an embodiment, the conceptual similarity is computed through the use of a technique called Latent Semantic Indexing (LSI). An example algorithm, which uses the LSI technique, aggregates blocks of text in a document into conceptually cohesive segments based on a set of (user-defined) aggregation criteria. Such an algorithm for subdividing document text can be implemented by software, firmware, hardware, or a combination thereof.

Overview

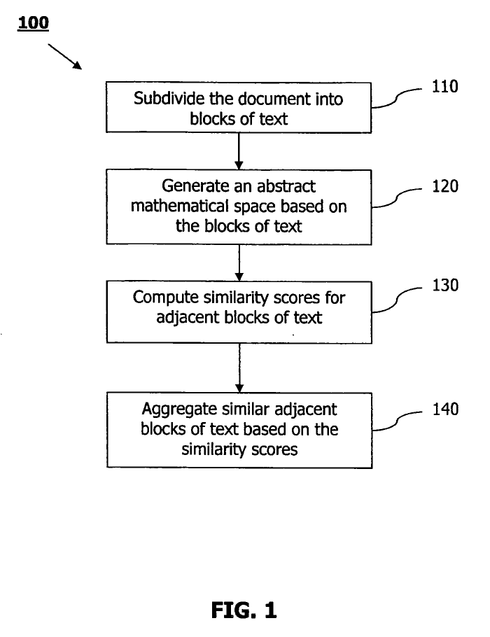

FIG. 1 illustrates a flowchart 100 of a method for automatically organizing a document into conceptually cohesive segments in accordance with an embodiment of the present invention. The method of flowchart 100 begins in a step 110, in which blocks of text contained in the document are subdivided into contiguous blocks. For example, the blocks of text can be clauses within sentences of the document, sentences contained in the document, groups of sentences contained in the document or some other block of text as would be apparent to a person skilled in the relevant art(s). Step 110 can be implemented by off-the-shelf software or other techniques known to a person skilled in the relevant art(s). An example of an off-the-shelf algorithm that can identify sentences in a document is a utility called “java.text.BreakIterator” provided within the Java™ 2 Platform. However, other well-known methods for determining sentence boundaries (such as identifying all words between punctuation marks) can be used without deviating from the spirit and scope of the present invention.

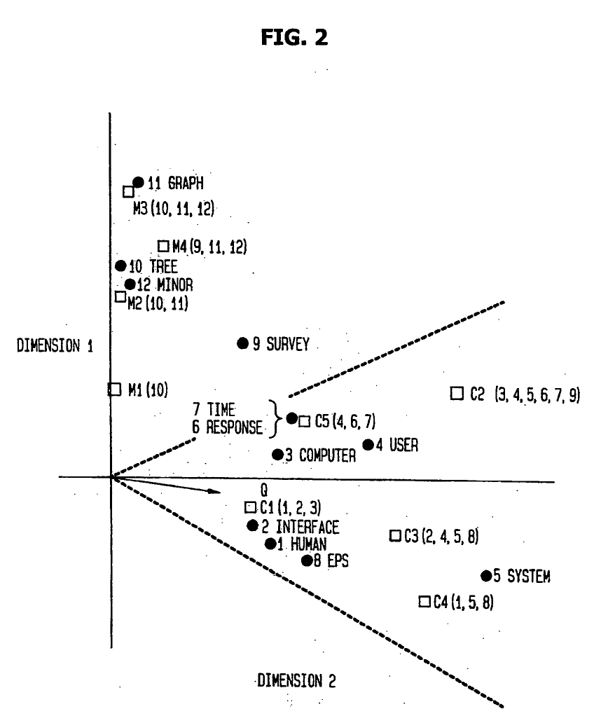

In a step 120, an abstract mathematical space is generated based on the blocks of texts, wherein each block of text has a representation in the abstract mathematical space. For example, each block of text can be represented as a vector in the abstract mathematical space. This can be done by treating each block of text as a document and using techniques, such as LSI, to compute a vector space containing the “documents.” The abstract mathematical space includes a similarity metric such that a conceptual similarity between the representation of any two blocks of text can be computed. As mentioned above, in an embodiment, the abstract mathematical space can be an LSI space as defined in U.S. Pat. No. 4,839,853 to Deerwester el al. (the '853 patent), the entirety of which is incorporated by reference as if fully set forth herein. The LSI technique is described below with reference to FIG. 2.

In a step 130, conceptual similarity scores are computed for adjacent blocks of text based on the representations of the adjacent blocks of text in the abstract mathematical space. In the example in which the blocks of text are represented as vectors, the conceptual similarity score between any two blocks of text computed in step 130 can be computed via a cosine measure between the vectors representing the two blocks of text. Examples of other similarity metrics can include, but are not limited to, a dot product metric, an inner product metric, a Euclidean distance metric, or some other metric as is known to a person having ordinary skill in the relevant art(s). The similarity scores for adjacent blocks of text can also incorporate information about blocks of text beyond the immediate neighbors to include broader neighborhood data. The criteria to compute these similarity scores, which are described in more detail below, can be based upon the following adjustable parameters: (i) spreadFactor, which defines the size of the neighborhood for comparisons to compute a similarity score; and (ii) useSpreadBest, which defines the manner in which to compute the similarity scores when more than one immediate neighbor is included in this neighborhood. However, the invention is not limited to these criteria.

In a step 140, similar adjacent blocks of text are aggregated into segments based on the similarity scores. The aggregation process continues so long as aggregation criteria are satisfied. The aggregation criteria, which are described in more detail below, can be based on one or more of the following adjustable parameters: (i) a maxNumSent, which defines a maximum number of blocks of text to include in each segment; (ii) preferredNumSent, which defines a preferred number of blocks of text to include in each segment; and (iii) minScore, which defines a minimum similarity threshold to permit aggregation. However, the invention is not limited to these criteria. As a result of the aggregation process, adjacent similar blocks of text are iteratively aggregated together until the criteria governing the operations disallow further aggregations. In this way, each set of aggregated block of text represents conceptually cohesive segments of the document text.

In an embodiment, the similarity computations of step 130 can be progressively computed during step 140 such as computing a single vector representing an aggregated block of text. In another embodiment, the aggregation criteria can be adjusted, thereby affecting the aggregation of the blocks of text in the document. This embodiment and alternatives thereof are described below.

As noted above, method 100 aggregates the blocks of text of a given document into conceptually cohesive segments by measuring the similarity between representations of the blocks of text in an abstract mathematical space. Because the abstract mathematical space is generated from the blocks of text of the document itself, several desirable features are achieved. For example, method 100 is language independent, provided the words and sentences can be extracted from the document. As another example, method 100 does not depend on a pre-set topic or collection of definitions. In fact, method 100 is independent of the topics or domain of the text. As a further example, method 100 does not require keyword analysis to find hints or cues of topic changes.

As mentioned above and described in the next section, in an embodiment, the abstract mathematical space generated in step 120 is an LSI space and the similarity computations in step 130 are cosine similarities between the vector representations of adjacent blocks of text. However, as will be apparent to a person skilled in the relevant art(s) from the description contained herein, other techniques can be used to measure a conceptual similarity between any two blocks of text in the document without deviating from the scope and spirit of the present invention.

Examples of other techniques that can be used to measure a conceptual similarity between blocks of text in accordance with embodiments of the present invention can include, but are not limited to, the following: (i) probabilistic LSI (see, e.g., Hofftnan, T., “Probabilistic Latent Semantic Indexing,” Proceedings of the 22^{nd} Annual SIGIR Conference, Berkeley, Calif., 1999, pp. 50-57); (ii) latent regression analysis (see, e.g., Marchisio, G., and Liang, J., “Experiments in Trilingual Cross-language Information Retrieval,” Proceedings, 2001 Symposium on Document Image Understanding Technology, Columbia, Md., 2001, pp. 169-178); (iii) LSI using semi-discrete decomposition (see, e.g., Kolda, T., and O. Leary, D., “A Semidiscrete Matrix Decomposition for Latent Semantic Indexing Information Retrieval,” ACM Transactions on Information Systems, Volume 16, Issue 4 (October 1998), pp. 322-346); and (iv) self-organizing maps (see, e.g., Kohonen, T., “Self-Organizing Maps,” 3^{rd} Edition, Springer-Verlag, Berlin, 2001). Each of the foregoing cited references is incorporated by reference in its entirety herein.

Latent Semantic Indexing (LSI)

Before discussing embodiments of the present invention, it is helpful to present a motivating example of LSI, which can also be found in the '853 patent mentioned above. This motivating example is used to explain the generation of an LSI space and the reduction of that space using a technique called Singular Value Decomposition (SVD). From this motivating example, a general overview of the mathematical structure of the LSI model is given, including a mathematical description of how to measure the conceptual similarity between objects represented in the LSI space. Application of LSI to text segmentation is then described.

Illustrative Example of the LSI Method

The contents of Table 1 are used to illustrate how semantic structure analysis works and to point out the differences between this method and conventional keyword matching.

TABLE 1
Document Set Based on Titles

c1: Human machine interface for Lab ABC computer applications
c2: A survey of user opinion of computer system response time
c3: The EPS user interface management system
c4: Systems and human systems engineering testing of EPS-2
c5: Relation of user-perceived response time to error measurement
m1: The generation of random, binary, unordered trees
m2: The intersection graph of paths in trees
m3: Graph minors IV: Widths of trees and well-quasi-ordering
m4: Graph minors: A survey

In this example, a file of text objects consists of nine titles of technical documents with titles c1-c5 concerned with human/computer interaction and titles m1-m4 concerned with mathematical graph theory. Using conventional keyword retrieval, if a user requested papers dealing with “human computer interaction,” titles c1, c2, and c4 would be returned, since these titles contain at least one keyword from the user request. However, c3 and c5, while related to the query, would not be returned since they share no words in common with the request. It is now shown how latent semantic structure analysis treats this request to return titles c3 and c5.

Table 2 depicts the “term-by-document” matrix for the 9 technical document titles. Each cell entry, (i,j), is the frequency of occurrence of term i in document j. This basic term-by-document matrix or a mathematical transformation thereof is used as input to the statistical procedure described below.

TABLE 2

| | DOCUMENTS | | | | | | | | |
|---|---|---|---|---|---|---|---|---|---|
| TERMS | c1 | c2 | c3 | c4 | c5 | m1 | m2 | M3 | m4 |
| Human | 1 | 0 | 0 | 1 | 0 | 0 | 0 | 0 | 0 |
| interface | 1 | 0 | 1 | 0 | 0 | 0 | 0 | 0 | 0 |
| computer | 1 | 1 | 0 | 0 | 0 | 0 | 0 | 0 | 0 |
| User | 0 | 1 | 1 | 0 | 1 | 0 | 0 | 0 | 0 |
| System | 0 | 1 | 1 | 2 | 0 | 0 | 0 | 0 | 0 |
| response | 0 | 1 | 0 | 0 | 1 | 0 | 0 | 0 | 0 |
| Time | 0 | 1 | 0 | 0 | 1 | 0 | 0 | 0 | 0 |
| EPS | 0 | 0 | 1 | 1 | 0 | 0 | 0 | 0 | 0 |
| Survey | 0 | 1 | 0 | 0 | 0 | 0 | 0 | 0 | 1 |
| Tree | 0 | 0 | 0 | 0 | 0 | 1 | 1 | 1 | 0 |
| Graph | 0 | 0 | 0 | 0 | 0 | 0 | 1 | 1 | 1 |
| Minor | 0 | 0 | 0 | 0 | 0 | 0 | 0 | 1 | 1 |

For this example the documents and terms have been carefully selected to yield a good approximation in just two dimensions for expository purposes. FIG. 2 is a two-dimensional graphical representation of the two largest dimensions resulting from the mathematical process of a singular value decomposition. Both document titles and the terms used in them are placed into the same representation space. Terms are shown as circles and labeled by number. Document titles are represented by squares with the numbers of constituent terms indicated parenthetically. The angle between two object (term or document) vectors describes their computed similarity. In this representation, the two types of documents form two distinct groups: all the mathematical graph theory titles occupy the same region in space (basically along Dimension 1 of FIG. 2) whereas a quite distinct group is formed for human/computer interaction titles (essentially along Dimension 2 of FIG. 2).

To respond to a user query about “human computer interaction,” the query is first folded into this two-dimensional space using those query terms that occur in the space (namely, “human” and “computer” ). The query vector is located in the direction of the weighted average of these constituent terms, and is denoted by a directional arrow labeled “Q” in FIG. 2. A measure of closeness or similarity is the angle between the query vector and any given term or document vector. In FIG. 2 the cosine between the query vector and each c1-c5 titles is greater than 0.90; the angle corresponding to the cosine value of 0.90 with the query is shown by the dashed lines in FIG. 2. With this technique, documents c3 and c5 would be returned as matches to the user query, even though they share no common terms with the query. This is because the latent semantic structure (represented in FIG. 2) fits the overall pattern of term usage across documents.

Description of Singular Value Decomposition

To obtain the data to plot FIG. 2, the “term-by-document” matrix of Table 2 is decomposed using singular value decomposition (SVD). A reduced SVD is employed to approximate the original matrix in terms of a much smaller number of orthogonal dimensions. The reduced dimensional matrices are used for retrieval; these describe major associational structures in the term-document matrix but ignore small variations in word usage. The number of dimensions to represent adequately a particular domain is largely an empirical matter. If the number of dimensions is too large, random noise or variations in word usage will be modeled. If the number of dimensions is too small, significant semantic content will remain uncaptured. For diverse information sources, 100 or more dimensions may be needed.

To illustrate the decomposition technique, the term-by-document matrix, denoted Y, is decomposed into three other matrices, namely, the term matrix (TERM), the document matrix (DOCUMENT), and a diagonal matrix of singular values (DIAGONAL), as follows:
Y_{t,d}=TERM_{t,k}DIAGONAL_{k,k}DOCUMENT_{k,d}^{T}
where Y is the original t-by-d matrix, TERM is the t-by-k matrix that has unit-length orthogonal columns, DOCUMENT^{T} is the transpose of the d-by-k DOCUMENT matrix with unit-length orthogonal columns, and DIAGONAL is the k-by-k diagonal matrix of singular values typically ordered by magnitude, largest to smallest.

The dimensionality of the solution, denoted k, is the rank of the t-by-d matrix, that is, k≦min(t,d). Table 3, Table 4, and Table 5 below show the TERM and DOCUMENT matrices and the diagonal elements of the DIAGONAL matrix, respectively, as found via SVD.

TABLE 3

| | TERM MATRIX (12 terms by 9 dimensions) | | | | | | | | |
|---|---|---|---|---|---|---|---|---|---|
| Human | 0.22 | −0.11 | 0.29 | −0.41 | −0.11 | −0.34 | −.52 | −0.06 | −0.41 |
| Inter- | 0.20 | −0.07 | 0.14 | −0.55 | 0.28 | 0.50 | −0.07 | −0.01 | −0.11 |
| face | | | | | | | | | |
| com- | 0.24 | 0.04 | −0.16 | −0.59 | −0.11 | −0.25 | −0.30 | 0.06 | 0.49 |
| puter | | | | | | | | | |
| User | 0.40 | 0.06 | −0.34 | 0.10 | 0.33 | 0.38 | 0.00 | 0.00 | 0.01 |
| System | 0.64 | −0.17 | 0.36 | 0.33 | −0.16 | −0.21 | −0.16 | 0.03 | 0.27 |
| Res- | 0.26 | 0.11 | −0.42 | 0.07 | 0.08 | −0.17 | 0.28 | −0.02 | −0.05 |
| ponse | | | | | | | | | |
| Time | 0.26 | 0.11 | −0.42 | 0.07 | 0.08 | −0.17 | 0.28 | −0.02 | −0.05 |
| EPS | 0.30 | −0.14 | 0.33 | 0.19 | 0.11 | 0.27 | 0.03 | −0.02 | −0.16 |
| Survey | 0.20 | 0.27 | −0.18 | −0.03 | −0.54 | 0.08 | −0.47 | −0.04 | −0.58 |
| Tree | 0.01 | 0.49 | 0.23 | 0.02 | 0.59 | −0.39 | −0.29 | 0.25 | −0.22 |
| Graph | 0.04 | 0.62 | 0.22 | 0.00 | −0.07 | 0.11 | 0.16 | −0.68 | 0.23 |
| Minor | 0.03 | 0.45 | 0.14 | −0.01 | −0.30 | 0.28 | 0.34 | 0.68 | 0.18 |

TABLE 4

| | DOCUMENT MATRIX (9 documents by 9 dimensions) | | | | | | | | |
|---|---|---|---|---|---|---|---|---|---|
| c1 | 0.20 | −0.06 | 0.11 | −0.95 | 0.04 | −0.08 | 0.18 | −0.01 | −0.06 |
| c2 | 0.60 | 0.16 | −0.50 | −0.03 | −0.21 | −0.02 | −0.43 | 0.05 | 0.24 |
| c3 | 0.46 | −0.13 | 0.21 | 0.04 | 0.38 | 0.07 | −0.24 | 0.01 | 0.02 |
| c4 | 0.54 | −0.23 | 0.57 | 0.27 | −0.20 | −0.04 | 0.26 | −0.02 | −0.08 |
| c5 | 0.28 | 0.11 | −0.50 | 0.15 | 0.33 | 0.03 | 0.67 | −0.06 | −0.26 |
| m1 | 0.00 | 0.19 | 0.10 | 0.02 | 0.39 | −0.30 | −0.34 | 0.45 | −0.62 |
| m2 | 0.01 | 0.44 | 0.19 | 0.02 | 0.35 | −0.21 | −0.15 | −0.76 | 0.02 |
| m3 | 0.02 | 0.62 | 0.25 | 0.01 | 0.15 | 0.00 | 0.25 | 0.45 | 0.52 |
| m4 | 0.08 | 0.53 | 0.08 | −0.02 | −0.60 | 0.36 | 0.04 | −0.07 | −0.45 |

TABLE 5
DIAGONAL (9 singular values)

| | | | | | | | | |
|---|---|---|---|---|---|---|---|---|
| 3.34 | 2.54 | 2.35 | 1.64 | 1.50 | 1.31 | 0.84 | 0.56 | 0.36 |

As alluded to earlier, data to plot FIG. 2 was obtained by presuming that two dimensions are sufficient to capture the major associational structure of the t-by-d matrix, that is, k is set to two in the expression for Y_{t,d}, yielding an approximation of the original matrix. Only the first two columns of the TERM and DOCUMENT matrices are considered with the remaining columns being ignored. Thus, the term data point corresponding to “human” in FIG. 2 is plotted with coordinates (0.22,-0.11), which are extracted from the first row and the two left-most columns of the TERM matrix. Similarly, the document data point corresponding to title m1 has coordinates (0.00,0.19), coming from row six and the two left-most columns of the DOCUMENT matrix. Finally, the Q vector is located from the weighted average of the terms “human” and “computer” appearing in the query. A method to compute the weighted average will be presented below.

General Model Details

It is now elucidating to describe in somewhat more detail the mathematical model underlying the latent structure, singular value decomposition technique.

Any rectangular matrix Y of t rows and d columns, for example, a t-by-d matrix of terms and documents, can be decomposed into a product of three other matrices:
Y₀=T₀S₀D₀^{T} (1)
such that T₀ and D₀ have unit-length orthogonal columns (i.e. T₀^{T}T₀=I; D₀^{T}D₀=I) and S₀ is diagonal. This is called the singular value decomposition (SVD) of Y. (A procedure for SVD is described in the text “Numerical Recipes,” by Press, Flannery, Teukolsky and Vetterling, 1986, Cambridge University Press, Cambridge, England), the entirety of which is incorporated by reference herein. T₀ and D₀ are the matrices of left and right singular vectors and S₀ is the diagonal matrix of singular values. By convention, the diagonal elements of S₀ are ordered in decreasing magnitude.

With SVD, it is possible to devise a simple strategy for an optimal approximation to Y using smaller matrices. The k largest singular values and their associated columns in T₀ and D₀ may be kept and the remaining entries set to zero. The product of the resulting matrices is a matrix Y_{R} which is approximately equal to Y, and is of rank k. The new matrix Y_{R} is the matrix of rank k which is the closest in the least squares sense to Y. Since zeros were introduced into S₀, the representation of S₀ can be simplified by deleting the rows and columns having these zeros to obtain a new diagonal matrix S, and then deleting the corresponding columns of T₀ and D₀ to define new matrices T and D, respectively. The result is a reduced model such that
Y_{R}=TSD^{T} (2)
The value of k is chosen for each application; it is generally such that k≧100 for collections of 1000-3000 data objects.

For discussion purposes, it is useful to interpret the SVD geometrically. The rows of the reduced matrices T and D may be taken as vectors representing the terms and documents, respectively, in a k-dimensional space. These vectors then enable the mathematical comparisons between the terms or documents represented in this space. Typical comparisons between two entities involve a dot product, cosine or other comparison between points or vectors in the space or as scaled by a function of the singular values of S. For example, if d₁ and d₂ respectively represent vectors of documents in the D matrix, then the similarity between the two vectors (and, consequently, the similarity between the two documents) can be computed as any of: (i) d₁·d₂, a simple dot product; (ii) (d₁·d₂)/(∥d₁∥×∥d₂∥), a simple cosine; (iii) (d₁S)·(d₂S), a scaled dot product; and (iv) (d₁S·d₂S)/(∥d₁S∥×∥d₂S∥), a scaled cosine.

LSI and Text Segmentation

As mentioned above, in an embodiment, an LSI space is generated based on blocks of text identified in a document. A similarity metric of the LSI space is then be used to aggregate the blocks of text of the document into conceptually cohesive segments. To make contact with the preceding example, the blocks of text are described as sentences in the example presented below. As mentioned above, blocks of text are not limited to sentences. Blocks of text are described as sentences in the example below for illustrative purposes only, and not limitation. Embodiments in which the blocks of text are not sentences will be apparent to a person skilled in the relevant art(s) from reading the description contained herein.

To generate the LSI space, the identified sentences are treated like the documents were treated in the LSI example described above. First, an input matrix of terms and sentences—i.e., a “term-by-sentence” matrix—is computed. The “term-by-sentence” matrix is analogous to the “term-by-document” matrix generated in the LSI example described above. Second, weighting algorithms are applied to the “term-by-sentence” matrix. Third, a rank reduced SVD is performed on the “term-by-sentence” matrix. Fourth, the LSI space vectors are extracted for the sentences (and terms). From these four steps, a ranked reduced “term-by-sentence” matrix will result, such that
A_{R}=TSZ^{T}, (3)
wherein: A_{R} is a rank reduced “term-by sentence” matrix analogous to the rank reduced “term-by-document” matrix Y_{R} of equation (2); T is a rank reduced term matrix analogous to the rank reduced term matrix T of equation (2); S is a rank reduced matrix of singular values analogous to the rank reduced matrix of singular values S of equation (2); and Z is a rank reduced matrix of sentences analogous to the rank reduced matrix of documents D of equation (2).

The conceptual similarity between any two sentences in this embodiment can be measured in an analogous manner to the measurement of the conceptual similarity between two documents described above.

Once an LSI space is generated from the sentences identified in a document and associated similarity scores have been computed, an algorithm can be applied to the vector representation of the sentences and similarity scores to subdivide the document into conceptually cohesive segments. The subdivision of the document can be based on the conceptual similarity between the sentences as measured by a similarity metric of the LSI space. Such an algorithm for subdividing a document into conceptually cohesive segments is described in the next section.

Example Algorithm

Given an LSI space generated from blocks of text identified in a document, the example algorithm described below subdivides the document into conceptually cohesive segments based on a conceptual similarity between the identified blocks of text. In other words, the example algorithm (i) computes similarity scores for adjacent blocks of text based on the representations of the adjacent blocks of text and (ii) aggregates similar adjacent blocks of text based on the similarity scores. This similarity computation and aggregation process may be repeated until no further aggregations can be achieved according to aggregation criteria, thereby resulting in a collection of conceptually cohesive segments of document text.

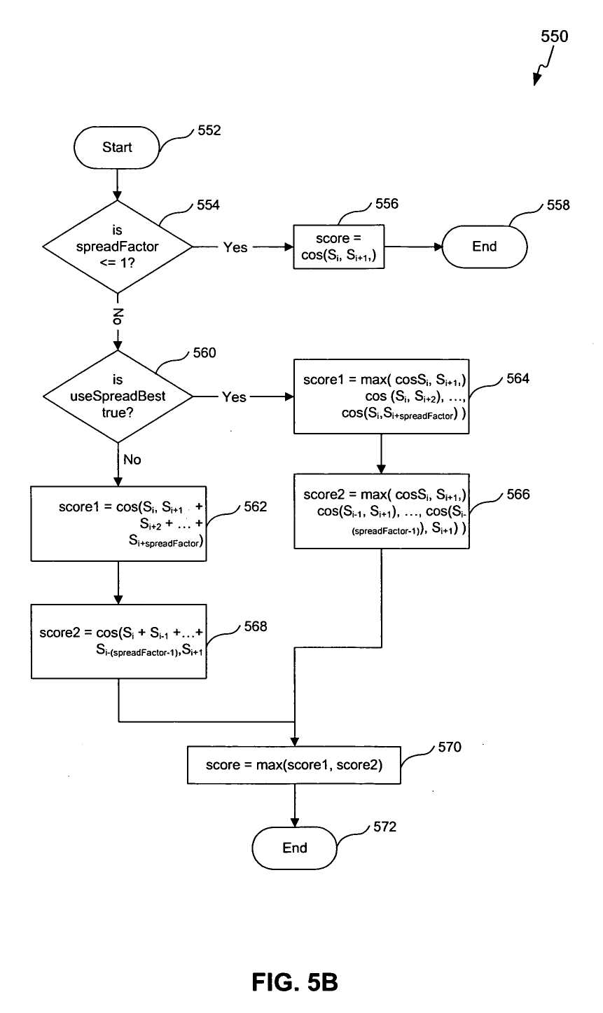

Before describing the operation of an example algorithm, adjustable parameters of the example algorithm are described. Depending on the settings of these adjustable parameters different classes of conceptual comparisons can be used during the aggregation process. After describing these classes of comparisons, a conceptual overview of the operation of an example algorithm is given. Then, a more detailed example algorithm is described with reference to FIGS. 5A and 5B.

Adjustable Parameters

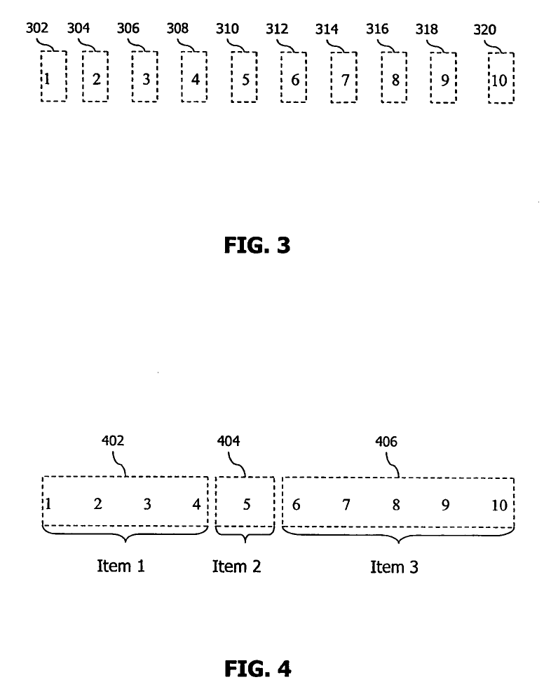

A set of adjustable parameters used by an algorithm in accordance with an embodiment of the present invention affects how blocks of text are aggregated into segments. In an embodiment, these adjustable parameters can be defined by a user. Aggregation criteria can be defined in terms of these adjustable parameters. The adjustable parameters may include: (1) a spreadFactor, which determines the “near neighbors” of a given block of text; (2) a useSpreadBest, which is a Boolean parameter that determines whether the similarity score computations are based on a comparison with a single “near neighbor” or a composite representation of the “near neighbors”; (3) maxNumSent, which defines a maximum number of blocks of text to be included in each segment; (4) a preferredNumSent, which defines a preferred number of blocks of text to be included in each segment; and (5) a minScore, which determines the minimum conceptual similarity required to aggregate two blocks of text. These adjustable parameters are described with reference to FIG. 3 FIGS. 5A and 5B depict flowcharts illustrating methods of using the adjustable parameters.

For illustrative purposes, and not limitation, the adjustable parameters and classes of comparisons are described based on the blocks of text being sentences. However, it is to be appreciated that blocks of text other than sentences can be used without deviating from the spirit and scope of the present invention. Likewise, other classes of comparisons can be used without deviating from the spirit and scope of the present invention.

FIG. 3 graphically depicts ten sentences identified in a document and their sequential relationship to each other. Each sentence identified in the document is depicted as a number and horizontally aligned. In this way, the number 1 included in box 302 represents the first sentence in the document, the number 2 included in box 304 represents the second sentence in the document, the number 3 included in box 306 represents the third sentence in the document, and so on. It is to be understood that the use of ten sentences is for illustrative purposes only, and not limitation. In fact, in most implementations the number of sentences in a document can be on the order of 100, 1 000, 10 000, 100 000, or some other number of sentences.

1. The spreadFactor will now be described. Without loss of generality, the spreadFactor is described with reference to sentence 5 (box 310). As mentioned above, the spreadFactor is a proximity threshold that determines the “near neighbors” of sentence 5. For example, if the spreadFactor is set equal to one, the “near neighbors” of sentence 5 would be those sentences that are within one unit to the right or left of sentence 5. In this example, the “near neighbors” of sentence 5 are sentence 4 (one unit to the left) and sentence 6 (one unit to the right). As another example, if the spreadFactor is set equal to two, the “near neighbors” of sentence 5 would be those sentences that are within two units to the right or left of sentence 5. In this example, the “near neighbors” of sentence 5 are sentence 3 (two units to the left), sentence 4 (one unit to the left), sentence 6 (one unit to the right), and sentence 7 (two units to the right). In a similar manner, the spreadFactor can be set equal to three, four, five, or some other value to adjust the number of “near neighbors” to a given sentence. In an embodiment of the present invention, the spreadFactor is set equal to three.

2. The useSpreadBest parameter is a Boolean parameter that determines whether the similarity score computation is based on a comparison with a single “near neighbor” or a composite of the “near neighbors.” If the useSpreadBest parameter is TRUE, then the computed score is with a single “near neighbor.” If the useSpreadBest parameter is FALSE, then the computed score is with a composite representation of multiple “near neighbors.” Note that the useSpreadBest parameter is irrelevant if the spreadFactor parameter is one, since “near neighbors” is thereby restricted to be only a single adjacent sentence.

3. As mentioned above, maxNumSent is one of the adjustable parameters. This adjustable parameter defines the maximum number of sentences to be included in a segment. In an embodiment, maxNumSent is set equal to 16. In this embodiment, no segment will include more than 16 sentences.

4. The preferredNumSent, which defines the preferred number of sentences to be included in each segment, is another of the adjustable parameters. In an embodiment, preferredNumSent is set equal to 5. A manner in which the algorithm attempts to realize segments with the preferred number of sentences is described below.

5. The minScore parameter is the minimum similarity required in order to aggregate adjacent blocks of text. A single segment would not contain two adjacent blocks of text for which the computed similarity at the boundary between the two blocks of text is less than minScore. For example, if the computed similarity between sentence 5 and sentence 6 is less than minScore, there would not be a segment that contained both sentence 5 and sentence 6. Note however, that the computed similarity between two adjacent sentences may involve more vector representations that those for the two sentences, based upon other adjustable parameters, and embodiments are free to recompute similarities during the aggregation process which could result in permitting aggregations between two sentences that initially failed the minScore criteria, but after some aggregations came to satisfy this criteria. In an embodiment, minScore is based on a minimum cosine similarity between the vector representation of adjacent blocks of text.

Classes of Comparisons

Depending on the values of the spreadFactor and the useSpreadBest parameters three distinct classes of similarity comparisons can be performed to compute similarity scores in this example embodiment. These three distinct classes correspond to (i) the spreadFactor being set equal to 1 regardless of the value of the useSpreadBest parameter, (ii) the spreadFactor being set to a value greater than 1 and the useSpreadBest parameter being TRUE, and (iii) the spreadFactor being set to a value greater than 1 and the useSpreadBest parameter being FALSE. Each of these three classes of comparisons will be described with reference to FIG. 3.

The classes of comparisons described below are for illustrative purposes only, and not limitation. That is, the three classes of comparisons described below are associated with the adjustable parameters presented above. Classes of comparisons other than those described below can be realized without deviating from the spirit and scope of the present invention. For example, other classes of comparisons can include, but are not limited to, averaging proximity weighted near neighbors, utilizing current aggregation boundaries to determine dynamic neighborhood sizes, recomputing similarity scores during aggregation, and other comparisons or similarity scoring algorithms as would be apparent to a person skilled in the relevant art(s) from reading the description contained herein.

Before describing each class of comparisons it is instructive to discuss some considerations about computing scores for adjacent sentence pairs, or generically at adjacent blocks of text boundaries. When computing the score comparing, for example, sentence 5 to sentence 6 of FIG. 3, if the spreadFactor is one then only sentences 5 and 6 are involved and a simple similarity metric such as a cosine can be applied to the representations of these two sentences to compute the similarity. However, if spreadFactor is greater than one, then more sentences are involved.

One way of approaching computing the similarity scores in this context of multiple sentences, which is illustrative but not limiting, is to consider the problem from two views. One being, continuing the example using sentences 5 and 6 of FIG. 3., how similar is sentence 5 to those after it? And, the other being how similar is sentence 6 to those before it? Both are relevant to scoring the similarity at this point to determine if an aggregation between the two should take place. Note that when spreadFactor is one, the comparison of sentence 5 to the single sentence after it, and the comparison of sentence 6 to the single sentence before it are equivalent.

In this context, and as described here, the spreadFactor parameter defines the number of sentences in the neighborhood following or to the right of the first of the two sentences at the comparison point, and it also defines the number of sentences in the neighborhood preceding or to the left of the second of the two sentences. Thus two similarity scores, a right score and a left score, can be computed at each boundary between adjacent sentences, or blocks of text, and the final similarity score could be selected as either the maximum of the two (as is done in the present example), the minimum of the two, or some other function combining the two scores such as averaging. Any of these techniques is within the scope and spirit of the present invention. Computational details of an example algorithm are described in the following sections.

The First Class of Comparisons. When the spreadFactor is set equal to 1, similarity scores are only computed for pairs of sentences that are one unit away from each other, or in other words are adjacent. The similarity score comparing an adjacent pair of sentences, such as sentences 5 and 6 of FIG. 3, is simply an application of the desired metric, such as a cosine, between the representations of the two sentences.

The Second Class of Comparisons. In this class of comparisons, the spreadFactor is set to a value greater than 1 and the useSpreadBest parameter is TRUE. Based on these values, computing the similarity score includes conceptually comparing a given sentence to at least one other sentence that follows or is to the right of and within the spreadFactor of the given sentence. For example, when the spreadFactor is set equal to three, the right “near neighbors” of sentence 5 are sentences 6, 7 and 8. When the useSpreadBest parameter is TRUE, the largest cosine similarity between sentence 5 and only one of sentences 6, 7 or 8 is used, in part, as a basis for aggregating these sentences. For example, the cosine similarity between sentence 5 and sentence 6 may be 0.05, the cosine similarity between sentence 5 and sentence 7 may be 0.95, and the cosine similarity between sentence 5 and sentence 8 may be 0.85. When the useSpreadBest parameter is TRUE, only the right cosine similarity between sentence 5 and sentence 7 (i.e., 0.95) will be used as a measure of the conceptual similarity between sentence 5 and its right “near neighbors” because this is the largest similarity value.

In addition to the cosine similarity of the given sentence (e.g., sentence 5) with its right near neighbors (e.g., sentences 6, 7, and 8), the algorithm computes the cosine similarity of the next sentence (e.g., sentence 6) with its left near neighbors (e.g., sentences 3, 4, and 5). The larger of these “left” and “right” cosine similarities is used to compute the single similarity value comparing a given segment (or sentence) with a next segment (or sentence).

From the above example, it is apparent that a segment can include sentences 5, 6, 7 and 8, despite the fact that the cosine similarity between the representation of sentence 5 and the representation of sentence 6 is less than the minScore. For instance, suppose the minScore is set equal to 0.1. In this case, because the cosine similarity between sentence 5 and sentence 6 is 0.05, it is less than the minScore. However, because the cosine similarity between sentence 5 and sentence 7 is relatively high (e.g., 0.95) and the spreadFactor is set to a value such that sentence 7 is a “near neighbor” of sentence 5, sentences 6, 7 and 8 could be aggregated with sentence 5, despite the fact that the conceptual similarity between sentence 5 and sentence 6 is below the minScore.

The Third Class of Comparisons. In this class of comparisons, the spreadFactor is set to a value greater than 1 and the useSpreadBest parameter is FALSE. Based on these values, computing the similarity score includes conceptually comparing a given sentence to a composite of the sentences that follow or are to the right of and within the spreadFactor of the given sentence. For example, as noted above, when the spreadFactor is set equal to three, the right “near neighbors” of sentence 5 are sentences 6, 7 and 8. When the useSpreadBest parameter is FALSE, then the vector representing sentence 5 is compared with a composite vector representation of its “near neighbors.” In this example, a vector will be generated in the LSI space that represents the average of the vector representations of sentences 6, 7 and 8. This composite vector will be conceptually compared to the vector representing sentence 5 as part of the determination as to whether sentences 5 and 6 may be aggregated into a segment during the aggregation process.

As mentioned above, the algorithm computes the cosine similarity of the given sentence (e.g., sentence 5) with the average of its right near neighbors (e.g., sentences 6, 7, and 8). In addition, the algorithm computes the cosine similarity of the next sentence (e.g., sentence 6) with the average of its preceding or left near neighbors (e.g., sentences 3, 4, and 5). The larger of these “right” and “left” cosine similarities is used to determine whether to aggregate a given segment (or sentence) with a next segment (or sentence) when the spreadFactor is greater than one and the useSpreadBest parameter is FALSE.

Conceptual Overview of Operation

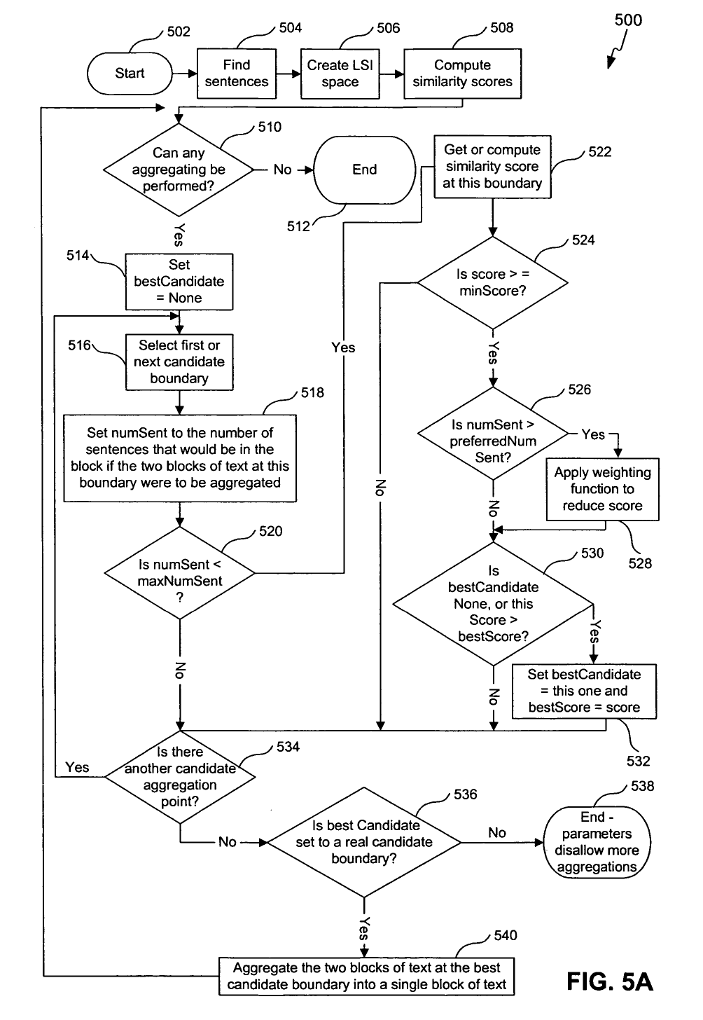

An overview of the operation of an example algorithm for aggregating a document into conceptually cohesive segments is now described with reference to FIGS. 3 and 4. Another embodiment is described with reference to FIGS. 5A and 5B. In an embodiment, the example algorithm can be implemented in computer code by a first and second WHILE loop; however, it will be apparent from the description contained herein that the example algorithm can be implemented in other manners. In this embodiment, the second WHILE loop is nested inside the first WHILE loop. Generally speaking, the second WHILE loop cycles through the adjacent sentence pairs in the document not aggregated together, determines the conceptual similarity between these sentence pairs as needed and finds the best candidate pair for aggregating, if any, and the first WHILE loop aggregates the best candidate adjacent sentences as found by the inner WHILE loop and then repeats the process until no more aggregation can occur. Based on the values of the adjustable parameters described above, aggregation criteria are used by the two WHILE loops to determine which sentences to aggregate. The functionality of the first and second WHILE loop can be more fully understood with reference to FIGS. 3 and 4.

As shown in FIG. 3, none of the ten sentences have been aggregated with any of the other sentences. To simplify the description of the first and second WHILE loops, it is assumed that the spreadFactor is set equal to one. In this case in a first iteration, the second WHILE loop computes a score based on the cosine similarity for aggregating each pair of adjacent sentences represented in FIG. 3. The manner in which the second WHILE loop computes the score is described in more detail below. Because there are ten sentences, the second WHILE loop could (potentially) compute nine scores: a first score based on the cosine similarity between sentence 1 and sentence 2, a second score based on the cosine similarity between sentence 2 and sentence 3, a third score based on the cosine similarity between sentence 3 and sentence 4, and so on. And, at the same time it will keep track of the best candidate aggregation point based upon the computed similarity scores.

The first WHILE loop aggregates the two sentences, or two blocks of text containing the two sentences, for which the score is the greatest as found above. For example, if the score between sentence 1 and sentence 2 is the largest of any of the nine scores computed by the second WHILE loop, then in the first iteration, sentences 1 and 2 will be aggregated into a segment or block of text by the first WHILE loop.

In a second iteration, if more aggregations can occur without violating the aggregation criteria, the second WHILE loop will compute the score for the remaining sentences and/or segments or blocks of sentences as aggregated text. Then, the first WHILE loop will aggregate the sentences, segments or combinations thereof for which the score is the highest.

After a certain number of iterations, the sentences may be aggregated into segments as depicted in FIG. 4. That is, sentences 1-4 may be aggregated into a segment 1, sentences 6-10 may be aggregated into an segment 3, and sentence 5 may be included in its own segment 2. As shown in the example of FIG. 4, in a next iteration sentence 5 could be included in segment 1 or segment 3. The second WHILE loop determines a score for aggregating segment 1 and sentence 5 and a score for aggregating sentence 5 and segment 3. Then the first WHILE loop will aggregate sentence 5 with the segment having the higher score, unless the adjustable parameter settings disallow this aggregation for some reason.

The manner in which the second WHILE loop determines a score for aggregating segments is described below with the assumption that the spreadFactor is set equal to three and the useSpreadBest parameter is FALSE.

The functionality of the second WHILE loop for different settings of the spreadFactor and useSpreadBest parameter will be apparent from the description contained herein. To determine a score for aggregating segment 1 and sentence 5, the second WHILE loop performs the following steps. First, it is determined whether aggregating segment 1 and sentence 5 violates the maximum number of sentences in each segment. For example, if maxNumSent is set equal to 4, aggregating segment 1 and sentence 5 would violate this parameter. In which case, segment 1 could not be aggregated with sentence 5, and the second WHILE loop would simply proceed to compute a score for aggregating sentence 5 and segment 3, if possible. If no aggregations are allowed then the text segmentation is complete and processing stops.

However, if aggregating segment 1 with sentence 5 does not exceed maxNumSent, then the second WHILE loop obtains the right score of the last sentence in segment 1 with respect to its right near neighbor sentences. In this example, the last sentence in segment 1 is sentence 4 and the right near neighbors of sentence 4 are sentences 5, 6, and 7 (because the spreadFactor is set equal to 3). With the useSpreadBest parameter set to FALSE, the right score of sentence 4 with respect to sentences 5, 6, and 7 would be the cosine similarity between the vector representing sentence 4 and the vector representing the composite of sentences 5, 6, and 7. In addition, the second WHILE loop obtains the left score of sentence 5 with respect to its left near neighbors. In this example, the left near neighbors of sentence 5 are sentences 2, 3, and 4. With the useSpreadBest parameter set to FALSE, the left score of sentence 5 with respect to sentences 2, 3, and 4 would be the cosine similarity between the vector representing sentence 4 and the vector representing the composite of sentences 2, 3, and 4. The score for aggregating segment 1 with sentence 5 will be the larger of the right score of sentence 4 with its right near neighbors and the left score of sentence 5 with its left near neighbors, provided one of these scores is greater than or equal to the minScore.

In a similar manner, the second WHILE loop will compute a score for aggregating sentence 5 with segment 3. Then, the first WHILE loop will aggregate sentence 5 with the segment for which the score is greater, provided that score is greater than or equal to the minScore. For example, if a first score for aggregating sentence 5 with segment 1 is greater than a second score for aggregating sentence 5 with segment 3, then the first WHILE loop will aggregate sentence 5 with segment 1, provided the first score is greater than or equal to the minScore.

Flowchart Illustrating Operation

FIG. 5A depicts a block diagram 500 illustrating an example method for aggregating sentences of a document into conceptually cohesive segments in accordance with an embodiment of the present invention.

Block diagram 500 is initiated in a step 502 and immediately proceeds to a step 504 in which all the blocks of text of a document are found. In a step 506, an LSI space is generated from the blocks of text found in step 504. The generation of the LSI space is similar to that described above. In a step 508, similarity scores between pairs of adjacent blocks of text are computed. The computation of the similarities is dependent on the value of the spreadFactor and the useSpreadBest parameter, as is apparent from the description above.

An example method for computing similarity scores is described below with respect to FIG. 5B. From the computation of all the comparisons, the cosine similarity between each sentence and its “near neighbors” (as defined by the spreadFactor) will be determined.

In a step 510, it is determined whether any blocks of text can be aggregated simply by noting if there are at least two blocks of text present. If no blocks of text can be aggregated, method 500 proceeds to a step 512 in which the method ends.

If, however, it is determined in step 510 that aggregations may be possible, method 500 proceeds to a step 514 in which a bestCandidate parameter is set equal to none. In other words, the bestCandidate parameter is initialized.

In a step 516, a first or next candidate boundary is selected. In step 518, numSent parameter is set to the number of sentences that would be in the resulting block of text if the two blocks of text at this boundary were to be aggregated.

The method then proceeds to a decision step 520 in which it is determined whether numSent is less than maxNumSent. If aggregating the two blocks of text at this candidate boundary exceeds maxNumSent, the method proceeds to a step 534. Otherwise it proceeds to a step 522. In step 522, the similarity score at this candidate boundary is obtained or computed. A method for computing the similarity score is presented below with respect to FIG. 5B. Then, method 500 proceeds to a decision step 524.

In step 524, the score computed in step 522 is compared to minScore. If the score is less than minScore, the method proceeds to a step 534. If, however, it is determined that the score is greater than or equal to minScore, method 500 proceeds to a decision step 526.

In step 526, if numSent exceeds preferredNumSent, then a weighting function is applied to the score for aggregating these two segments as indicated in a step 528. This weighting function can reduce the score to possibly favor other candidate boundary scores that would result in smaller combined numbers of sentences. From step 528 the method proceeds to a step 530.

If, however, in step 526 it is determined that aggregating the current segment with the next segment will not exceed preferredNumSent, the method proceeds directly to step 530. If in step 530, it is determined that bestCandidate is none or the score is greater than the current best score, the bestCandidate is set equal to the current candidate boundary and the best score is set equal to the current score as indicated in a step 532.

If, however, in step 530 it is determined that the score is not greater than the best score, the method proceeds to step 534 to determine if there is another candidate aggregation point.

If there is another candidate aggregation point, method 500 cycles back to step 516. However, if it is determined that there are not other candidate aggregation points, method 500 proceeds to decision step 536 in which it is determined whether bestCandidate is set to a real candidate boundary. If bestCandidate is not set to a real candidate boundary, method 500 ends at a step 538. If, however, it is determined in step 536 that bestCandidate is a real candidate boundary, method 500 proceeds to a step 540 in which the two blocks of text at the best candidate boundary are aggregated into a single block of text. Then, method 500 cycles back to step 510.

The above-described method ignores sentences represented by null vectors. However, it is to be appreciated that an algorithm that does not ignore null vectors is within the scope and spirit of the present invention.

FIG. 5B is a flowchart illustrating a method 550 for computing the similarity score between adjacent blocks of text, Sᵢ and Sᵢ₊₁. Method 550 begins at a step 552 and immediately proceeds to a decision step 554.

If, in step 554, it is determined that spreadFactor is less than or equal to 1, then in a step 556 the score is set equal to the cosine between the two representations of adjacent blocks of text, Sᵢ and Sᵢ₊₁. From step 556, method 550 ends at a step 558.

If, however, in step 554, it is determined that spreadFactor is greater than 1, then method 550 proceeds to a decision step 560. In step 560, if useSpreadBest is true, then a first (right) score is set equal to the maximum cosine similarity between the representations of block of text Sᵢ and another block of text that is to the right of and within the spreadFactor of Sᵢ, as indicated in a step 564. In a step 566, a second (left) score is set equal to the maximum cosine similarity between the representations of block of text Sᵢ₊₁ and another block of text that is to the left of and within the spreadFactor of Sᵢ₊₁. Then, method 550 proceeds to a step 570.

If, in step 560, it is determined that useSpreadBest is not set equal to true, method 550 proceeds to a step 562. In step 562, a first (right) score is set equal to the cosine of the representation of block of text Sᵢ with the sum of the representations of all blocks of text to the right of and within the spreadFactor of Sᵢ. In step 568, a second (left) score is set equal to the cosine of the representation of block of text Sᵢ₊₁ with the sum of the representations of all blocks of text to the left of and within the spreadFactor of Sᵢ₊₁. Then, method 550 proceeds to step 570.

In step 570, a score is set equal to the maximum of the first score and the second score. Then, method 550 ends at step 572.

Example Computer System Implementation

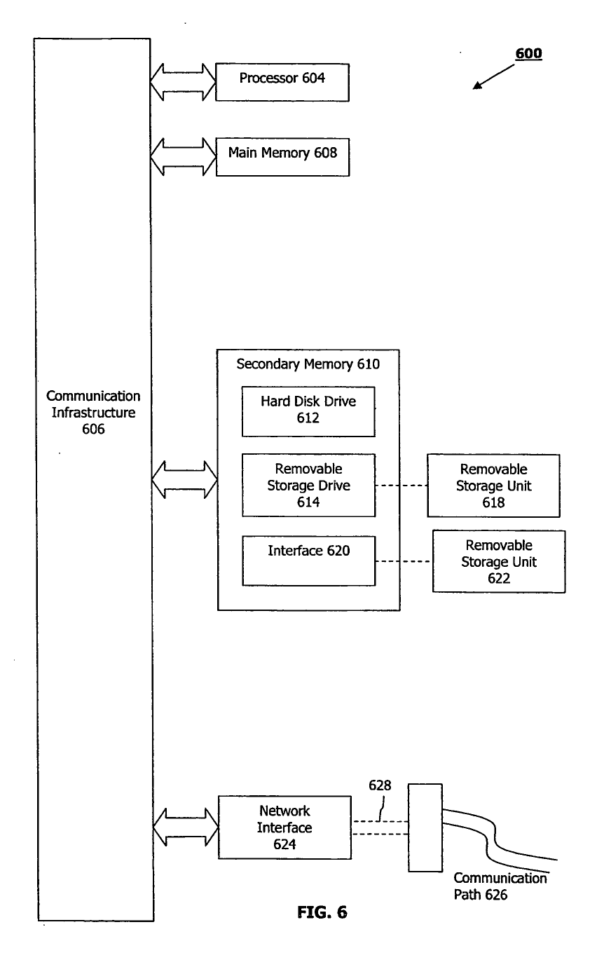

Several aspects of the present invention can be implemented by software, firmware, hardware, or a combination thereof. FIG. 6 illustrates an example computer system 600 in which an embodiment of the present invention, or portions thereof, can be implemented as computer-readable code.

For example, the methods illustrated by flowchart 100 of FIG. 1, flowchart 500 of FIG. 5A and flowchart 550 of FIG. 5B can be implemented in system 600. Various embodiments of the invention are described in terms of this example computer system 600. After reading this description, it will become apparent to a person skilled in the relevant art how to implement the invention using other computer systems and/or computer architectures and/or combinations of other computer systems.

Computer system 600 includes one or more processors, such as processor 604. Processor 604 can be a special purpose or a general purpose processor. Processor 604 is connected to a communication infrastructure 606 (for example, a bus or network).

Computer system 600 also includes a main memory 608, preferably random access memory (RAM), and may also include a secondary memory 610. Secondary memory 610 may include, for example, a hard disk drive 612 and/or a removable storage drive 614. Removable storage drive 614 may comprise a floppy disk drive, a magnetic tape drive, an optical disk drive, a flash memory, or the like. The removable storage drive 614 reads from and/or writes to a removable storage unit 618 in a well known manner. Removable storage unit 618 may comprise a floppy disk, magnetic tape, optical disk, etc. which is read by and written to by removable storage drive 614. As will be appreciated by persons skilled in the relevant art(s), removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 are in the form of signals 628 which may be electronic, electromagnetic, optical, or other signals capable of being received by communications interface 624. These signals 628 are provided to communications interface 624 via a communications path 626. Communications path 626 carries signals 628 and may be implemented using wire or cable, fiber optics, a phone line, a cellular phone link, an RF link or other communications channels.

In this document, the terms “computer program medium” and “computer usable medium” are used to generally refer to media such as removable storage unit 618, removable storage unit 622, a hard disk installed in hard disk drive 612, and signals 628. Computer program medium and computer usable medium can also refer to memories, such as main memory 608 and secondary memory 610, which can be memory semiconductors (e.g. DRAMs, etc.). These computer program products are means for providing software to computer system 600.

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor 604 to implement the processes of the present invention, such as the steps in the methods illustrated by flowchart 100 of FIG. 1, flowchart 500 of FIG. 5A and flowchart 550 of FIG. 5B, discussed above. Accordingly, such computer programs represent controllers of the computer system 600. Where the invention is implemented using software, the software may be stored in a computer program product and loaded into computer system 600 using removable storage drive 614, interface 620, hard drive 612 or communications interface 624.

The invention is also directed to computer products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

Example Capabilities and Applications

The embodiments of the present invention described herein have many capabilities and applications. The following example capabilities and applications are described below: monitoring capabilities; categorization capabilities; output, display and/or deliverable capabilities; and applications in specific industries or technologies. These examples are presented by way of illustration, and not limitation. Other capabilities and applications, as would be apparent to a person having ordinary skill in the relevant art(s) from the description contained herein, are contemplated within the scope and spirit of the present invention.

Monitoring Capabilities. As mentioned above, embodiments of the present invention can be used to monitor different media outlets to identify an item and/or information of interest. The item and/or information can be identified based on a similarity measure between a conceptually cohesive segment of a document that represents the item and/or information and a query (such as, a user-defined query). By way of illustration, and not limitation, the item and/or information of interest can include, a particular brand of a good, a competitor's product, a competitor's use of a registered trademark, a technical development, a security issue or issues, and/or other types of items either tangible or intangible that may be of interest. The types of media outlets that can be monitored can include, but are not limited to, email, chat rooms, blogs, web-feeds, websites, magazines, newspapers, and other forms of media in which information is displayed, printed, published, posted and/or periodically updated.

Information gleaned from monitoring the media outlets can be used in several different ways. For instance, the information can be used to determine popular sentiment regarding a past or future event. As an example, media outlets could be monitored to track popular sentiment about a political issue. This information could be used, for example, to plan an election campaign strategy.

Categorization Capabilities. As mentioned above, a document can be segmented into conceptually cohesive segments in accordance with an embodiment of the present invention and these segments can be coupled with other categorization techniques. Example applications in which embodiments of the present invention can be coupled with categorization capabilities can include, but are not limited to, employee recruitment (for example, by matching resumes to job descriptions), customer relationship management (for example, by characterizing customer inputs and/or monitoring history), call center applications (for example, by working for the IRS to help people find tax publications that answer their questions), opinion research (for example, by categorizing answers to open-ended survey questions), dating services (for example, by matching potential couples according to a set of criteria), and similar categonrzation-type applications.

Output, Display and/or Deliverable Capabilities. Conceptually cohesive segments of a document identified in accordance with an embodiment of the present invention and/or products that use such a segmented document in accordance with an embodiment of the present invention can be output, displayed and/or delivered in many different manners. Example outputs, displays and/or deliverable capabilities can include, but are not limited to, an alert (which could be emailed to a user), a map (which could be color coordinated), an unordered list, an ordinal list, a cardinal list, cross-lingual outputs, and/or other types of output as would be apparent to a person having ordinary skill in the relevant art(s) from reading the description contained herein.

Applications in Technology, Intellectual Property and Pharmaceuticals Industries. The conceptual segmentation of a document described herein can be used in several different industries, such as the Technology, Intellectual Property (IP) and Pharmaceuticals industries. Example applications of embodiments of the present invention can include, but are not limited to, prior art searches, patent/application alerting, research management (for example, by identifying patents and/or papers that are most relevant to a research project before investing in research and development), clinical trials data analysis (for example, by analyzing large amount of text generated in clinical trials), and/or similar types of industry applications.

Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A method for automatically organizing a document into conceptually cohesive segments, comprising:
(a) subdividing the document into contiguous blocks of text;
(b) generating an abstract mathematical space based on the blocks of text, wherein each block of text has a representation in the abstract mathematical space;
(c) computing similarity scores for adjacent blocks of text based on the representations of the adjacent blocks of text; and
(d) aggregating similar adjacent blocks of text based on the similarity scores.

2. The method of claim 1, wherein step (b) comprises:
(b) generating a Latent Semantic Indexing (LSI) space based on the blocks of text, wherein each block of text has a representation in the LSI space.

3. The method of claim 2, wherein step (c) comprises:
(c) computing cosine similarities for adjacent blocks of text based on the representations of the adjacent blocks of text.

4. The method of claim 2, wherein step (c) comprises:
(c) computing similarity scores for adjacent blocks of text based on the representations of the adjacent blocks of text, wherein computing a similarity score comprises computing at least of one a dot product, a scaled dot product, a scaled cosine, an inner product, or a Euclidean distance.

5. The method of claim 1, wherein step (c) comprises:
(c) computing a similarity between the representation of a first block of text and the representation of at least one other block of text that is within a proximity threshold of the first block of text.

6. The method of claim 1, wherein step (c) comprises:
(c) computing a similarity between a first plurality of representations of blocks of text and a second plurality of representations of blocks of text, wherein the second plurality of blocks of text are within a proximity threshold of the first plurality of blocks of text.

7. The method of claim 1, further comprising:
(e) computing a similarity between the representation of a first block of text and the representation of respective blocks of text in an aggregated segment of text, wherein each block of text in the aggregated segment of text is within a proximity threshold of the first block of text.

8. The method of claim 7, further comprising:
(f) aggregating the first block of text and the aggregated segment of text based on a maximum similarity computed in step (e).

9. The method of claim 7, further comprising:
(f) aggregating the first block of text and the aggregated segment of text based on a composite similarity computed in step (e).

10. The method of claim 1, wherein steps (c) and (d) comprise:
(c1) computing a similarity between the representation of a first block of text and a composite representation of a plurality of blocks of text, wherein each block of text in the plurality of blocks of text is within a proximity threshold of the first block of text; and
(d1) aggregating the first block of text and the plurality of blocks of text based on the similarity computed in step (c1).

11. The method of claim 1, wherein steps (c) and (d) further comprise:
(c1) computing a first similarity of the representation of a first block of text with respect to the representation of a second block of text that is to the right of and within a proximity threshold of the first block of text;
(c2) computing a second similarity of the representation of the second block of text with respect to the representation of a block of text that is to the left of and within a proximity threshold of the second block of text; and
(d) aggregating the first block of text and the second block of text based on a comparison of the first and second similarities.

12. The method of claim 1, further comprising:
(e) computing a similarity between the representation of a last block of text in an aggregated segment of text and the representation of a second plurality of blocks of text, wherein each block of text in the second plurality of blocks of text is within a proximity threshold of the last block of text in the aggregated segment of text; and
(f) aggregating the first aggregated segment of text and the second plurality of blocks of text into a second aggregated segment of text based on the similarity computed in step (e).

13. A computer program product for automatically organizing a document into conceptually cohesive segments, comprising:
a computer usable medium having computer readable program code means embodied in said medium for causing an application program to execute on an operating system of a computer, said computer readable program code means comprising:
a computer readable first program code means for subdividing the document into contiguous blocks of text;
a computer readable second program code means for generating an abstract mathematical space based on the blocks of text, wherein each block of text has a representation in the abstract mathematical space;
a computer readable third program code means for computing similarity scores for adjacent blocks of text based on the representations of the adjacent blocks of text; and
a computer readable fourth program code means for aggregating similar adjacent blocks of text based on the similarity scores.

14. The computer program product of claim 13, wherein the second computer readable program code means comprises:
means for generating a Latent Semantic Indexing (LSI) space based on the blocks of text, wherein each block of text has a representation in the LSI space.

15. The computer program product of claim 14, wherein the third computer readable program code means comprises:
means for computing cosine similarities for adjacent blocks of text based on the representations of the adjacent blocks of text.

16. The computer program product of claim 14, wherein the third computer readable program code means comprises:
means for computing similarity scores for adjacent blocks of text based on the representations of the adjacent blocks of text, wherein computing a similarity score comprises computing at least one of a dot product, a scaled dot product, a scaled cosine, an inner product, or a Euclidean distance.

17. The computer program product of claim 13, wherein the third computer readable program code means comprises:
means for computing a similarity between the representation of a first block of text and the representation of at least one other block of text that is within a proximity threshold of the first block of text.

18. The computer program product of claim 13, wherein the third computer readable program code means comprises:
means for computing a similarity between a first plurality of representations of blocks of text and a second plurality of representations of blocks of text, wherein the second plurality of blocks of text are within a proximity threshold of the first plurality of blocks of text.

19. The computer program product of claim 13, further comprising:
a computer readable fifth program code means for computing a similarity between the representation of a first block of text and the representation of respective blocks of text in an aggregated segment of text, wherein each block of text in the aggregated segment of text is within a proximity threshold of the first block of text.

20. The computer program product of claim 19, further comprising:
a computer readable sixth program code means for aggregating the first block of text and the aggregated segment of text based on a maximum similarity computed by the fifth computer readable program code means.

21. The computer program product of claim 19, further comprising:
a computer readable sixth program code means for aggregating the first block of text and the aggregated segment of text based on a composite similarity computed by the fifth computer readable program code means.

22. The computer program product of claim 13, wherein:
the third computer readable program code means comprises means for computing a similarity between the representation of a first block of text and a composite representation of a plurality of blocks of text, wherein each block of text in the plurality of blocks of text is within a proximity threshold of the first block of text; and
the fourth computer readable program code means comprises means for aggregating the first block of text and the plurality of blocks of text based on the similarity computed by the third computer readable program code means.

23. The computer program product of claim 13, wherein:
the third computer readable program code means comprises means for (i) computing a first similarity of the representation of a first block of text with respect to the representation of a second block of text that is to the right of and within a proximity threshold of the first block of text, and (ii) computing a second similarity of the representation of the second block of text with respect to the representation of a block of text that is to the left of and within a proximity threshold of the second block of text; and
the fourth computer readable program code means comprises means for aggregating the first block of text and the second block of text based on a comparison of the first and second similarities.

24. The computer program product of claim 13, further comprising:
a computer readable fifth program code means for computing a similarity between the representation of a last block of text in an aggregated segment of text and the representation of a second plurality of sentences, wherein each sentence in the second plurality of sentences is within a proximity threshold of the last block of text in the aggregated segment of text; and
a computer readable sixth program code means for aggregating the first segment and the second plurality of sentences into a second segment based on the similarity computation.
